(19) United States
(12) Patent Application Publication
(10) Pub. No.: US 2026/0358463 A1
(43) Pub. Date: Nov. 12, 2026

(54) ACOUSTIC SENSING METHOD AND SYSTEM

(71) Applicant: UNIVERSITY OF TASMANIA, Sandy Bay, Tasmania (AU)

(72) Inventors: Brian SALMON, Sandy Bay, Tasmania (AU); Damien HOLLOWAY, Sandy Bay, Tasmania (AU); Tim FINNIGAN, Sandy Bay, Tasmania (AU)

(21) Appl. No.: 19/474,519

(22) PCT Filed: Apr. 11, 2024
(86) PCT No.: PCT/AU2024/050344

§ 371 Date: Oct. 10, 2025

(30) Foreign Application Priority Data
Apr. 12, 2023 (AU) 2023901065

(51) Int. Cl. G01S 5/30

(52) U.S. Cl. CPC G01S 5/30

(57) ABSTRACT

An acoustic sensing system is provided for generating an acoustic map to identify one or more sounds sources in an area of interest comprising an acoustic sensor array comprising a plurality of acoustic sensor elements arranged in an initial configuration, each acoustic sensor element being configured to receive acoustic data from the area of interest including the one or more sound sources; an optical imaging apparatus comprising an image sensor configured to receive optical image data representative of the area of interest; one or more processors in communication with the acoustic sensor array and the optical imaging apparatus, the processor configured to generate an acoustic map that includes the acoustic data and the optical image data; determine an optimised configuration of acoustic sensor elements to enhance the acoustic map; cause the acoustic sensor elements to be arranged into the optimised configuration; and generate an optimised acoustic map that includes the acoustic data received from the acoustic sensor elements arranged in the optimised configuration together with the optical image data; wherein the optimised configuration includes adjustments to the acoustic sensor elements to focus on a particular sound source or enhance focus on one or more selected sound sources. A method for generating an acoustic map to identify one or more sound sources in an area of interest is also provided.

### CROSS-REFERENCE TO RELATED APPLICATIONS

This application is a national phase entry of, and claims priority to, International Patent Application No. PCT/AU2024/050344 (filed 11 Apr. 2024) which claims priority to AU 2023901065 (filed 12 Apr. 2023). The entire contents of these applications are incorporated herein by reference.

### TECHNICAL FIELD

The present invention relates to a method and system for acoustic sensing and imaging. It relates more specifically to an acoustic camera.

### BACKGROUND OF INVENTION

An acoustic camera is a sensing and imaging device adapted to locate and characterise sound sources. As shown in FIG. 1, acoustic camera 100 uses a microphone array 105 comprising a plurality of microphones to collect acoustic data or signals and process, via processing element 110 such as field programmable gate array (FPGA), acoustic data to form a representation of the location of the sensed sound sources, referred to as an acoustic map. The acoustic camera 100 may include an optical camera 115 to enable the acoustic map to be superimposed onto an optical image to provide a real-world representation of the location of the sound sources which is transmitted to display 120 to be viewed by a user. This allows a user to intuitively recognise the parts of machinery and equipment that emit sounds, for example.

Acoustic cameras have application in many fields, including mining, automotive, medical, computer and consumer electronic industries, to assist users in locating and identifying sources of sound including abnormal or unexpected sound sources (e.g. vibrations of an engine or turbine). For example, in FIG. 2, an acoustic map 200 is superimposed onto an optical image 210, to illustrate how an acoustic map can be used to ascertain that noise is emanating from an industrial machine 220. It will therefore be appreciated that acoustic cameras offer potential benefits to product development in terms of both noise diagnosis and reduction.

An acoustic map is generated by processing data from dozens of microphones, typically anywhere from 24 to 192, although not necessarily restricted to that range, mounted in an array. The configuration of the microphone array can be two-dimensional or three-dimensional. FIG. 3 shows a variety of microphone arrays which are commercially available, including two-dimensional and some three-dimensional examples.

Since sound propagates at a known speed, in acoustic mapping, a sound source is perceived by the microphones at different points in time and at different sound intensities, dependent on the location of the sound source and the location of the microphone which is known. Referring now to FIG. 4, the distance between the sound source 400 and each microphone 410, 420 of the array will not be equal, i.e. d₁≠d₂, such that the sound waves received by each microphone 410, 420 in the array will have a phase difference. Separation between microphones (distance x) enables reliable and accurate estimation of the location of each sound source.

Acoustic data is recorded for a period of time and then converted to digital format given a certain distortion rate. The resulting digital recorded acoustic data is transmitted to a Field Programmable Gate Array (FPGA) or similar for processing. The task of the FPGA is to generate an acoustic map from the acoustic data using the time delay information. The FPGA computes the acoustic map pixel by pixel. It first determines the relative time delay at each microphone for any hypothetical incoming acoustic signal from any direction displayed in the acoustic map. Various algorithms can be used to compute the acoustic map from the time delay differences, with one simple and commonly used algorithm known as delay-and-sum (DAS) being the basis for all other algorithms.

The resulting acoustic map is overlaid onto an optical image for ease of identification of the location of the sound sources. Additional external inputs such as the geometric layout and distance from camera, combined with a more sophisticated version of the delay-and-sum algorithm, can be used to enhance the accuracy and/or precision of the estimate of the magnitude and location of the sound source.

The quality of the acoustic map is a function of the accuracy of the estimation of the location and intensity of the sound sources observed by the acoustic camera. Most known acoustic cameras have a microphone array having a fixed topology or installation structure. Consequently, the arrangement of the microphone array has little flexibility which results in each array only being suitable for a limited and specific environment and is therefore generally not suitable for working in more complex environments, for example, an environment having multiple sound sources. Higher frequency sounds sources require microphones to be spaced closer together for improved resolution, whilst microphones which are more separated are more conducive to mapping lower frequency sound sources.

In an attempt to address this shortcoming in existing acoustic cameras, they have been produced in a variety of shapes and sizes to make them more suitable for mapping sounds in particular environments. Moreover, some commercially available acoustic cameras are configured for manual adjustment of the microphone array by a human operator. This functionality makes these types of acoustic camera suitable for a broader variety of environments, but requires operator experience and intuition to achieve consistent and reliable results. The cost of such commercial acoustic cameras is relatively high, limiting access.

It would therefore be desirable to provide an acoustic camera with a microphone array having a more flexible topology that can be adapted to different environments.

A reference herein to a patent document or any other matter identified as prior art, is not to be taken as an admission that the document or other matter was known or that the information it contains was part of the common general knowledge as at the priority date of any of the claims.

### SUMMARY OF INVENTION

According to an aspect of the present invention, there is provided an acoustic sensing system for generating an acoustic map to identify one or more sounds sources in an area of interest comprising an acoustic sensor array comprising a plurality of acoustic sensor elements arranged in an initial configuration, each acoustic sensor element being configured to receive acoustic data from the area of interest including the one or more sound sources; an optical imaging apparatus comprising an image sensor configured to receive optical image data representative of the area of interest; one or more processors in communication with the acoustic sensor array and the optical imaging apparatus, the processor configured to generate an acoustic map that includes the acoustic data and the optical image data; determine an optimised configuration of acoustic sensor elements to enhance the acoustic map; cause the acoustic sensor elements to be arranged into the optimised configuration; and generate an optimised acoustic map that includes the acoustic data received from the acoustic sensor elements arranged in the optimised configuration together with the optical image data; wherein the optimised configuration includes adjustments to the acoustic sensor elements to focus on a particular sound source or enhance focus on one or more selected sound sources.

In one embodiment, the optimised configuration may include a varied spatial position of one or more of the plurality of acoustic sensor elements in the acoustic sensor array.

In another embodiment, the optimised configuration includes a varied gain of one or more of the plurality of acoustic sensor elements in the acoustic sensor array.

In yet another embodiment, the optimised configuration includes a varied spatial position and a varied gain of one or more of the plurality of acoustic sensor elements in the acoustic sensor array.

The processor may determine the optimised configuration of the acoustic sensor elements using an optimisation algorithm.

In one embodiment, the acoustic sensor array comprises a plurality of acoustic sensor elements arranged on one or more sensor mounting members extending from a housing. The one or more sensor mounting members may be rotatably mounted. Each sensor mounting member may be connected to the housing via a hinged member. In some forms of the invention, the one or more sensor mounting members are rotatably mounted to a hinged member extending from the housing.

In some embodiments, at least one sensor mounting member has a disc-like geometry. In other embodiments, at least one sensor mounting member has an angular shape.

Each sensor mounting member may have at least one acoustic sensor element arranged thereon to allow for movement of the acoustic sensor elements relative to other acoustic sensor elements.

In some embodiments, the acoustic sensing system further includes actuation means configured to arrange the acoustic sensor elements into the optimised configuration.

In one particular embodiment, one or more members comprise an arm, each arm being hingedly connected to a support structure. Each arm may comprise a plurality of segments, each segment being hingedly connected to an adjoining segment. Each segment may have at least one acoustic sensor element arranged thereon to allow for movement of each acoustic sensor element relative to each other acoustic sensor element.

The acoustic sensor system may further include actuation means configured to arrange the acoustic sensor elements within the acoustic sensor array mounted on sensor mounting members to be arranged into the optimised configuration. The actuation means may be an electric motor or a shape memory alloy actuator wire. The shape memory alloy actuator wire may comprise Muscle Wire® or Nitinol®, for example.

According to yet another aspect of the present invention, there is provided a method for generating an acoustic map to identify one or more sound sources in an area of interest, the method comprising the following steps: receiving, by an acoustic sensor array comprising a plurality of acoustic sensor elements arranged in an initial configuration, acoustic data from the area of interest; receiving optical image data representative of the area of interest; generating an acoustic map that includes the acoustic data and the optical image data; determining an optimised configuration of acoustic sensor elements to enhance the acoustic map; causing the acoustic sensor elements in the acoustic sensor array to be arranged into the optimised configuration; and generating an optimised acoustic map that includes the acoustic data received from the acoustic sensor elements arranged in the optimised configuration together with the optical image data; wherein the optimised configuration includes adjustments to the acoustic sensor elements to focus on a particular sound source or enhance focus on one or more selected sound sources.

In one embodiment, the optimised configuration includes varying a spatial position of one or more of the plurality of acoustic sensor elements in the acoustic sensor array.

In another embodiment, the optimised configuration includes varying a gain of one or more of the plurality of acoustic sensor elements in the acoustic sensor array.

In yet another embodiment, the optimised configuration includes varying a spatial position and a gain of one or more of the plurality of acoustic sensor elements in the acoustic sensor array.

In some embodiments, the steps of generating the acoustic map, determining the optimised configuration of acoustic sensor elements to enhance the acoustic map and causing the acoustic sensor elements in the acoustic sensor array to be arranged into the optimised configuration are repeated until the acoustic map is optimised for the area of interest.

The step of determining an optimised configuration of acoustic sensor elements to enhance the acoustic map may involve performing one or more of the following steps:
a. establishing a frequency range of one or more selected sound sources and adjusting a spacing between acoustic sensor elements for each sound source;
b. repositioning the acoustic sensor array to identify potential obstructions in an environment surrounding the area of interest;
c. varying a relative angle of one or more acoustic sensor elements to enhance side-lobe suppression; and/or
d. adjusting a subset of the acoustic sensor elements for one or more detected sound sources.

In some embodiments, adjusting a subset of the acoustic sensor elements for each sound source detected includes adjusting the spatial position and/or the gain of one or more acoustic sensing elements.

### BRIEF DESCRIPTION OF DRAWINGS

The invention will now be described in greater detail with reference to the accompanying drawings in which like features are represented by like numerals. It is to be understood that the embodiments shown are examples only and are not to be taken as limiting the scope of the invention as defined in the claims appended hereto.

FIG. 1 shows a schematic of a prior art acoustic camera system.

FIG. 2 shows an exemplary acoustic map produced by a prior art acoustic camera system.

FIG. 3 shows a variety of prior art acoustic cameras having microphone arrays of various configurations.

FIG. 4 is a schematic diagram showing acoustic data from a single sound source arriving at microphones separated by a distance.

FIG. 5 shows a schematic of an acoustic camera system according to an embodiment of the present invention.

FIGS. 6A and 6B show a comparison of acoustic maps generated by alternative microphone arrays.

FIG. 7 shows a schematic of an acoustic camera according to an embodiment of the present invention.

FIGS. 8A and 8B show a perspective view of an alternative embodiment of the acoustic sensing system.

FIG. 9A is a front on perspective view of alternative embodiment of the acoustic sensing system, whilst FIG. 9B is a perspective back view of the same acoustic sensing system.

FIGS. 10A and 10B show a perspective view of yet another alternative embodiment of the acoustic sensing system.

FIGS. 11A and 11B show a perspective view of still another alternative embodiment of the acoustic sensing system.

FIG. 12A is a front on view of an embodiment of the acoustic sensing system focusing on the housing.

FIG. 12B is a side on view of the housing of FIG. 12A.

FIG. 12C is a front on view of a user holding the acoustic sensing system of FIGS. 12A and 12B to illustrate comparative size according to an embodiment.

FIGS. 13A to 13E shown the acoustic sensing system of FIGS. 12A, 12B and 12C, in various stages of set up and deployment.

FIGS. 14A to 14C show how different acoustic sensor array configurations can be achieved by rotating sensor mounting members about a pivot.

FIGS. 15A to 15G show a series of acoustic maps generated by sound sources having different frequencies.

FIG. 16 is a flowchart showing an improved method of producing an acoustic map according to an embodiment of the invention.

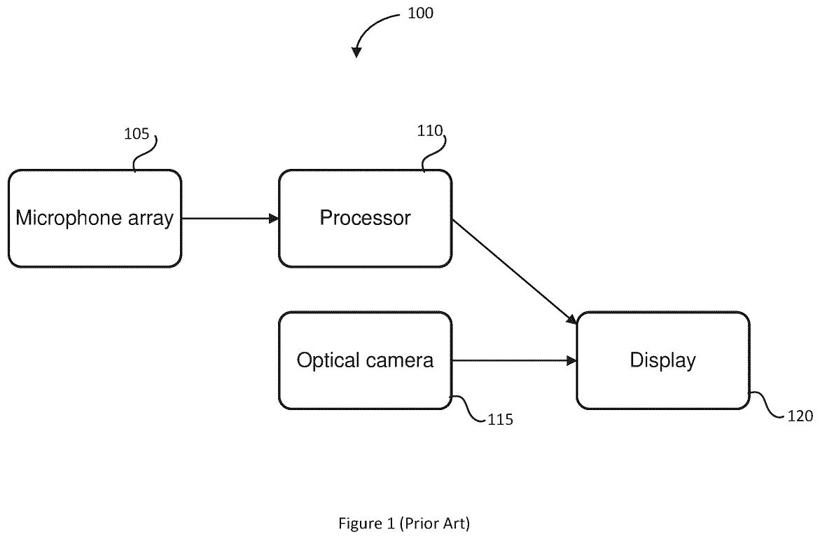

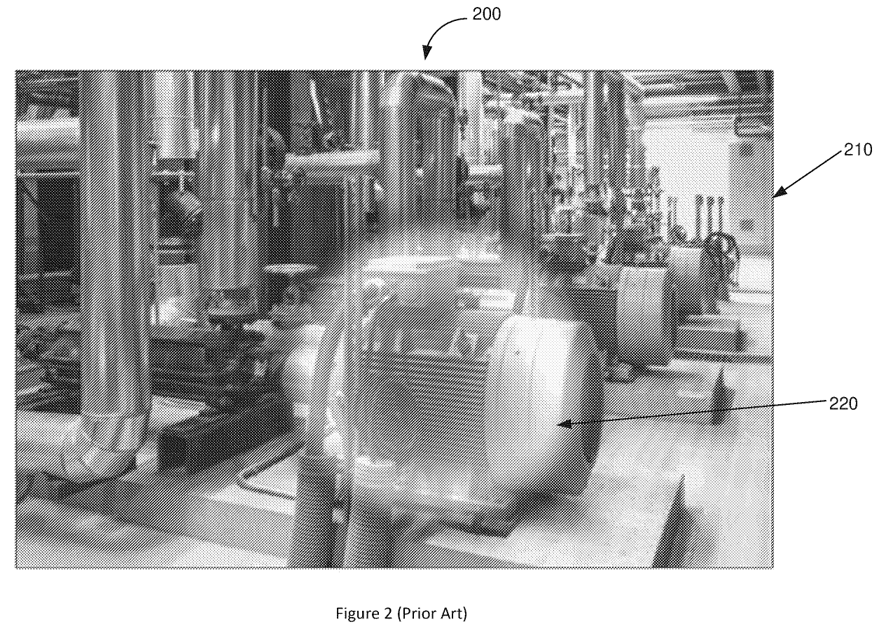

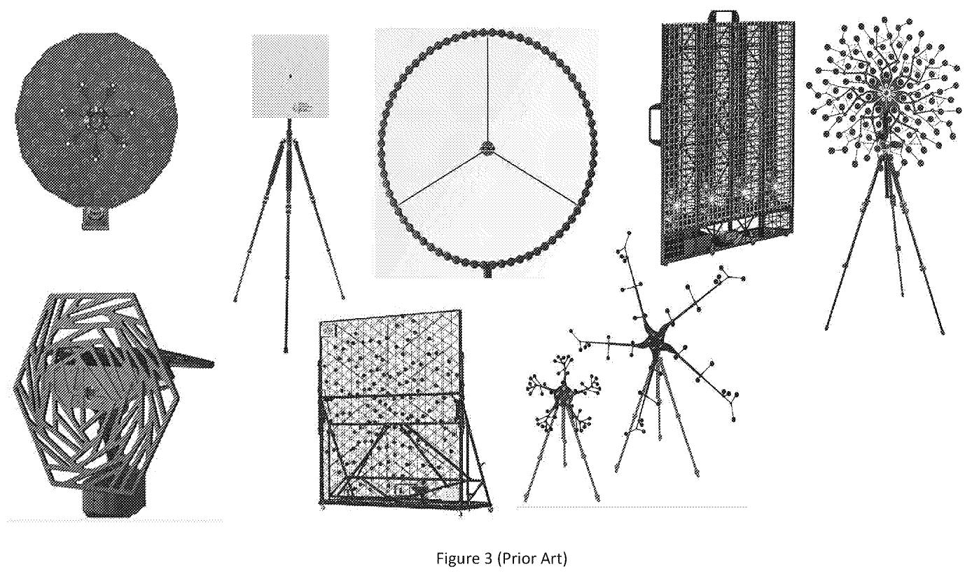

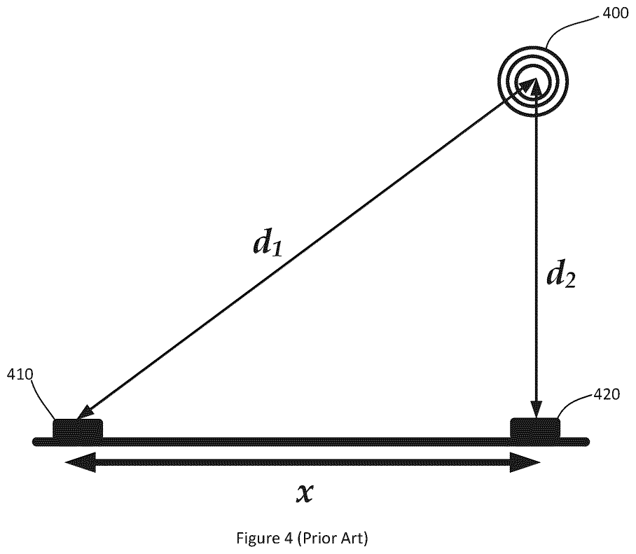

### DETAILED DESCRIPTION

Embodiments of the invention are discussed herein by reference to the drawings which are not to scale and are intended merely to assist with explanation of the invention.

An acoustic sensing system is provided including an acoustic sensor array comprising a plurality of acoustic sensor elements or microphones arranged in an initial configuration. Each acoustic sensor element receives acoustic data or signals from an area of interest including one or more sound sources. The acoustic sensing system further includes a processor in communication with the acoustic sensor array to determine an optimised configuration for the acoustic sensor elements within the array. The optimised configuration is intended to enhance the acoustic data received from the area of interest. The acoustic sensor elements within the acoustic sensor array are subsequently rearranged into the optimised configuration. Consequently, the acoustic sensor elements in the acoustic sensor array can be reconfigured to adapt the acoustic sensing system to optimise acoustic sensing within a particular environment of interest. This improved functionality makes the acoustic sensing system suitable for a broader variety of environments when compared with conventional acoustic sensing systems.

What constitutes the optimised configuration will vary depending on the sound sources present in the area of interest, and the particular focus of the user. For example, a user may wish to identify and characterise all sound sources within an area of interest. Or a user may wish to focus on one or more selected sound sources in the area of interest. For instance, the user may wish to filter white noise or background noise from the acoustic map output. Therefore, optimisation involves making adjustments to the available acoustic sensor elements to focus sensing on a particular sound source only or to enhance focus on one or more selected sound sources.

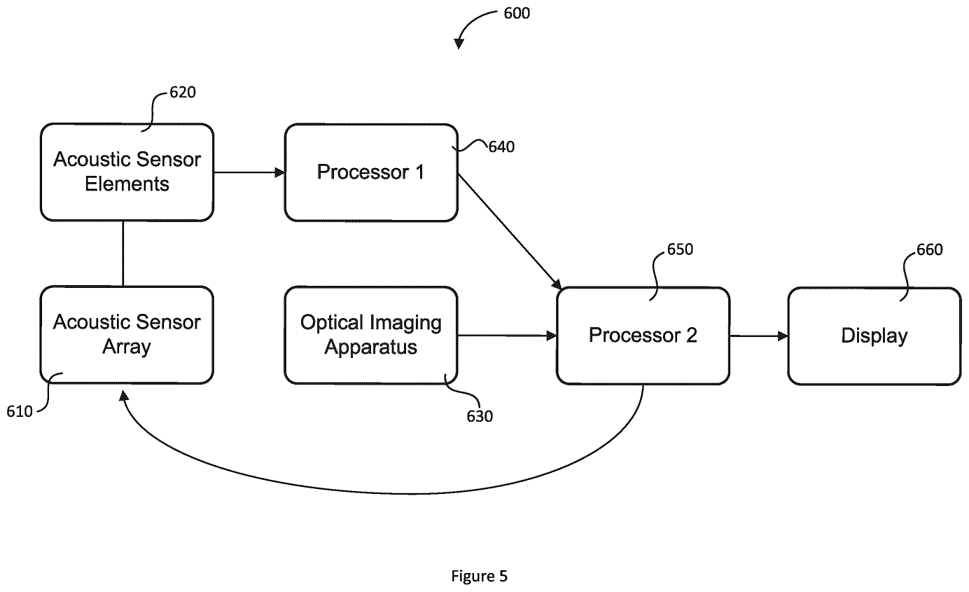

Referring now to FIG. 5, there is shown an acoustic camera system 600 according to an embodiment. The acoustic sensing system comprises an acoustic sensor array 610 comprising a plurality of acoustic sensor elements or microphones 620 arranged in an initial configuration. The configuration of the acoustic sensing array could be two-dimensional or three-dimensional. Each acoustic sensor element 620 is configured to receive acoustic data from one or more sound sources in the surrounding environment, referred to herein as the area of interest. The acoustic camera system 600 may further include an optical imaging apparatus 630 including an image sensor configured to receive optical image data representative of the area of interest. A first processor 640 is provided in communication with the acoustic sensor elements 620 and the optical imaging apparatus 630. First processor 640 may comprise a field programmable gate array (FPGA) or similar processing element. Processor 640 is configured to generate an acoustic map based on the acoustic data and the optical image data. The acoustic sensing system 600 further comprises a second processor 650 configured to determine an optimised configuration for the acoustic sensor elements 620 that will enhance the acoustic map and causes the acoustic sensor elements to be arranged into the optimised configuration. It will be appreciated that the reference to a first processor and a second processor is reflective of their function, but that the first processor and second processor may be provided as a single field programmable gate array (FPGA) or similar processing element. An optimised acoustic map is generated including the acoustic data received from the acoustic sensor elements 620 arranged in the optimised configuration, together with the optical image data and transmitted to display 660 to be viewed by a user.

The optimised configuration of acoustic sensor elements 620 is determined using an optimisation algorithm. Further details and examples of the optimisation algorithm are provided herein.

At any given point in time, the acoustic sensor array 610 will exist in a certain configuration or topological state. This is referred to as the initial configuration of the acoustic sensor array 610. Whilst the acoustic sensor array is in the initial configuration, a processor 640, such as a field programmable gate array, is configured to produce an acoustic map or sound map representative of the area of interest. A second processor 650 is configured to detect the dominant sound source or sources and estimate their location and intensity before determining an optimised configuration for the acoustic sensor array 610 to enhance the resulting acoustic map.

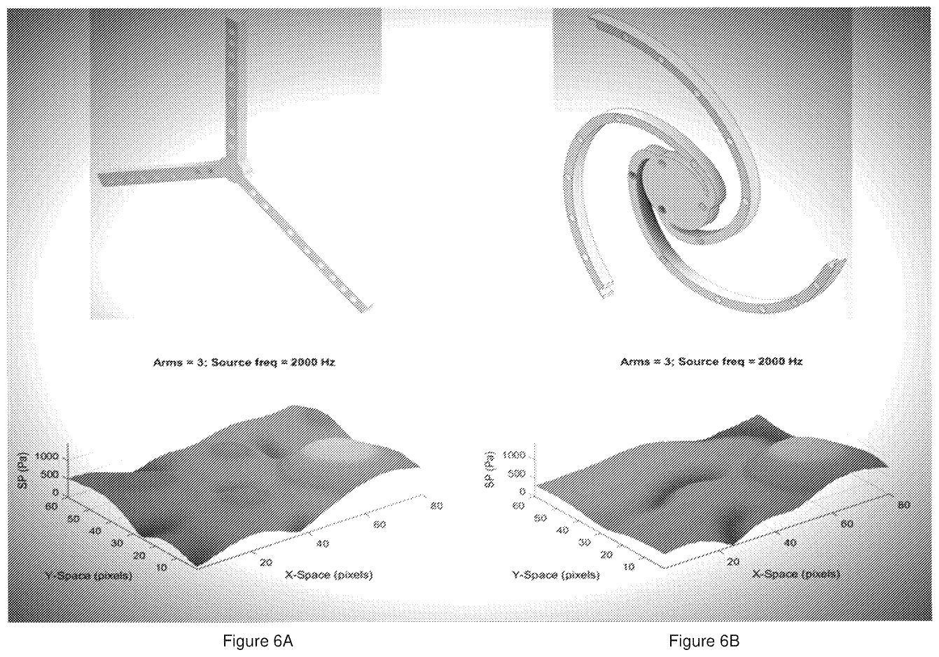

Referring now to FIGS. 6A and 6B, there is shown a comparison of two alternate acoustic sensing array configurations and the respective impact on the resulting acoustic map. That is, it can be observed that the same sound frequency sense by two different array configurations, namely the star array shown in FIG. 6A, and the Underbrink array shown in FIG. 6B. Both arrays have similar minimum distances (i.e. high frequency range) and maximum distances (i.e. low frequency range) with regard to the respective distribution of acoustic sensing elements, and it can be ascertained from the simulation outputs produced by Matlab that both acoustic sensing arrays consistently and correctly identify the sound source. The observable difference in the acoustic maps generated by sensing with the Underbrink array (FIG. 6B) versus the Star array (FIG. 6A) is that the noise artefacts (i.e. false peaks and troughs) around the sound source are suppressed using Underbrink array. This demonstrates that the acoustic map can be optimised for the same sound source of sources by adopting a different configuration for the acoustic sensing array. Note that no attempt has been made to optimise these acoustic sensing arrays, FIGS. 6A and 6B are merely a demonstration that a relatively minor change to the array configuration can significantly enhance the acoustic map.

Examples of changes that may be made to the acoustic sensing array configuration include but are not limited to one or more of the following:
a. establishing a frequency range of one or more sound sources and adjusting the spacing between acoustic sensor elements for each sound source;
b. repositioning the acoustic sensing array in response to potential obstructions in an environment surrounding the area of interest;
c. varying a relative angle of each acoustic sensing element to enhance side-lobe suppression; and/or
d. adjusting a subset of acoustic sensing elements for each sound source detected, e.g. adjusting the spatial position and/or the gain of one or more acoustic sensing elements.

Accordingly, it will be appreciated that the acoustic sensing system 600 shown in FIG. 5 comprises an adaptive acoustic sensor array 610 that allows the configuration of individual acoustic sensing elements 620 within the acoustic sensing array 610 to be adjusted relative to one another, i.e. their spatial position, and/or to have their signal gains or sensitivities adjusted. The position or location of each acoustic sensing element is tracked and known at least intermittently if not at all times. An optimiser algorithm suggests appropriate adjustments to be made to the spatial position or gains of the acoustic sensor elements, to either focus on a particular sound source thereby enhancing clarity, or enhancing focus on one or more selected sound sources, i.e. resulting in an improvement in average performance. For example, where the sound sources can be visualised on a graphical user interface (GUI) following acoustic mapping with the acoustic sensing array in an initial configuration, a user may select, for example on a touch screen or using a cursor, the sound sources on which to focus for a particular “optimised” iteration of the acoustic map. These features impart an “auto-focus” capability upon the acoustic sensing system to provide an intelligent acoustic sensing system enabling improved interactions with the complexities of the real world.

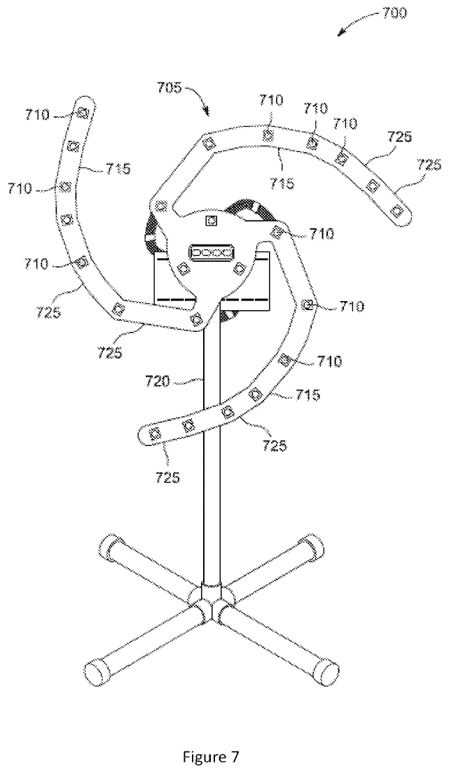

The acoustic sensor array 610 may take various physical forms that enable adjustment of the relative spatial position of individual acoustic sensing elements within the acoustic sensing array 610. Referring now to FIG. 7, in one particular embodiment, the acoustic sensing system 700 comprises acoustic sensing elements 710 arranged in an adaptable mechanical array 705 having a plurality of moveable arms 715 hingedly connected to a support structure 720. Each arm 715 comprises a plurality of segments 725 with each segment being hingedly connected to an adjoining segment. Preferably, each segment 725 has at least one acoustic sensor element 710 arranged thereon to allow for movement of each acoustic sensor element relative to each other acoustic sensor element.

The control mechanism or actuation means for moving each segment 725 having an acoustic sensor element 710 mounted thereon is selected from any suitable means, including but not limited to: one or more electric motors; one or more shape memory alloy actuator wires; polymer artificial muscle; and/or magnetism. In a particular embodiment, the shape memory alloy actuator wire comprises Muscle Wire® or Nitinol®.

Considerations for selecting suitable actuation means include, but are not limited to, requirements for speed (i.e. slow or fast movement), variations in angle (i.e. 2D or 3D, complex angles comprising multiple arms or segments, spiral angles, etc.), need for noise minimisation (i.e. to avoid audio or other interference signals), transition (i.e. smooth unhindered, provided by gears, motion artefacts, etc.), all of which can impact acoustic data or signal quality captured by the acoustic sensing elements.

In the specific embodiment shown in FIG. 7, the acoustic sensing system 700 has three arms 715 each comprising of seven segments 725 which are interconnected by controllable joints. The controllable joints are adjustable via interconnected muscle wires. Muscle wires expand and contract based on the electrical current flowing therethrough. Based on contraction and expansion of the set of muscle wires, positional and velocity control of each segment is provided. As each segment 725 is moved, the acoustic sensing element 710 or microphone mounted on the segment is also moved. Since muscle wire generates no audible noise, the acoustic sensing array can be adjusted in near-real time without causing any interference in generation of the acoustic map.

Moreover, the arms 715 of FIG. 7 are arranged in a substantially spiral array, or more specifically, a multi-spiral array. It will be appreciated the other topologies or configurations will have equal or similar utility in certain environments. The present configuration is shown merely for illustrative purposes.

The acoustic sensing system 700 includes an optical camera 730 to enable the resulting acoustic map to be superimposed onto an optical image to provide a user with a real-world representation of the location of the sound sources.

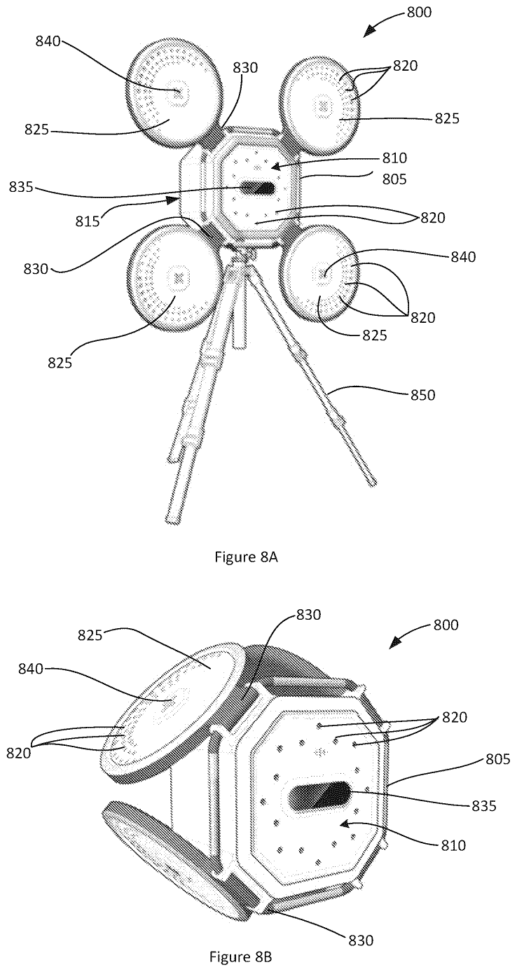

Referring now to FIGS. 8A and 8B, there is shown an alternative embodiment wherein the acoustic sensing system 800 comprises a housing 805 having a front side 810 and a back side 815. Acoustic sensing elements 820 are provided on front side 810 of housing 805, as well as on a plurality of sensor mounting members 825, shown here as lobes or discs. It will be appreciated that sensor mounting members could take any suitable shape or geometry, including but not limited to curved or angular shapes, and two-or three-dimensional objects. That is, the sensor mounting members could be substantially planar or flat, or could incorporate a curve or dish, such the acoustic sensor members mounted thereon are not distributed in a single plane. Sensor mounting members 825 being connected to housing 805 via hinged members 830. The manner of connection of sensor mounting members 825 to housing 805 enables the sensor mounting members, and accordingly, the acoustic sensing elements 820 mounted thereon, to be repositioned at various angles to housing. Moreover, the sensor mounting members 825 are rotatably attached to a distal end of hinged member 830. This allows a further degree of movement, wherein the sensor mounting members 825 can rotate about a pivot 840. Preferably, although not necessarily, the pivot 840 is centrally located with respect to the sensor mounting member 825. These different means of movement enables acoustic sensing elements 820 to be arranged in an adaptable array.

As shown in FIG. 8A, in one position, sensor mounting members 825 are in the same plane as front side 810 of housing 805. As shown in FIG. 8B, in another position, sensor mounting members 825 are folded back such that they are positioned substantially perpendicular to housing 805. In the folded back position, acoustic sensing system 800 is reduced to a minimum size, which is convenient for transport and storage. It will be appreciated that each sensor mounting member 825 can be moved to a variety of positions anywhere between those shown in FIGS. 8A and 8B, or even such that they are positioned forward of the plane in which the front side 810 of housing 805 lies. Such degrees of movement in each sensor mounting member 825, enables acoustic sensing elements 820 mounted thereon to be moved relative to other acoustic sensing elements mounted on adjacent sensor mounting members, to permit adjustment of the acoustic sensor array towards an optimised configuration which focuses on a particular sound source or enhances focus on one or more selected sound sources.

In the embodiment shown in FIGS. 8A and 8B, optical imaging apparatus or camera 835 is conveniently provided within housing 805 to form a compact unit. Processing capability may also be provided within housing 805 or alternatively the acoustic sensing system 800 may be in wireless communication with one or more processors provided in a remotely located computer system (not shown).

Acoustic sensing system 800 may be provided on telescopic legs 850, for example, to provide adaptable support and height adjustment such that the acoustic sensing system can be deployed in a variety of environments. Telescopic legs 850 may, for example, be provided in a tripod configuration, as shown in FIG. 8A.

Referring now to FIG. 9As and 9B, there is shown yet another embodiment. Acoustic sensing system 900 differs from acoustic sensing system 800 shown in FIGS. 8A and 8B, firstly in the pattern of distribution of acoustic sensing elements 905 provided on sensor mounting members 910 rotatably mounted to hinged members 925 via pivot 930 and also on front side 915 of housing 920. Furthermore, camera 935 has an aperture of a different shape than camera 835 shown in FIGS. 8A and 8B. Acoustic sensing system 900 further differs from acoustic sensing system 800 shown in FIGS. 8A and 8B in that sensor mounting members 910 are configured to be folded back 180° so as to tuck into storage compartment at the back of housing 920 when not in use. This provides a more streamlined structure for transport and storage. Hinged members 925 are each configured to be foldable for this purpose.

Referring now to FIGS. 10A and 10B, there is shown still another embodiment. Acoustic sensing system 1000 shown in FIG. 10A has a similar distribution of acoustic sensing elements 1005 provided on the sensor mounting members 1010 as acoustic sensing system 800 of FIGS. 8A and 8B but a different distribution of acoustic sensing elements as acoustic sensing system 900 of FIGS. 9A and 9B. Sensor mounting members 1010, provide a planar surface for mounting the acoustic sensing elements 1005, similar to the lobe or disc-shape sensor mounting members 825 and 910 shown previously, but have a more angular shape, for example, square or rectangular. It will be appreciated that the sensor mounting members can take any suitable shape or form provided they provide a surface for mounting acoustic sensing elements that can be positioned in various ways. Acoustic sensing system 1000 further allows for discrete storage of sensor mounting members 1010 when not in use. In this case, the sensor mounting members 1010 are configured to be disconnected from housing 1015 by releasable connection means and can be received into slot 1020 provided in housing 1015 for that purpose as is shown in FIG. 10B. In another embodiment, sensor mounting members 1010 may be configured to be folded into the housing for storage without first detaching them. In this embodiment, sensor mounting members 1010 are attached to housing 1015 by suitable attachment means which enables the sensor mounting members to be deployed as required and manoeuvred for storage. This could for example, comprise a pivoting attachment means, such as a pin or shaft. A camera aperture 1025 is provided in front face of housing 1015.

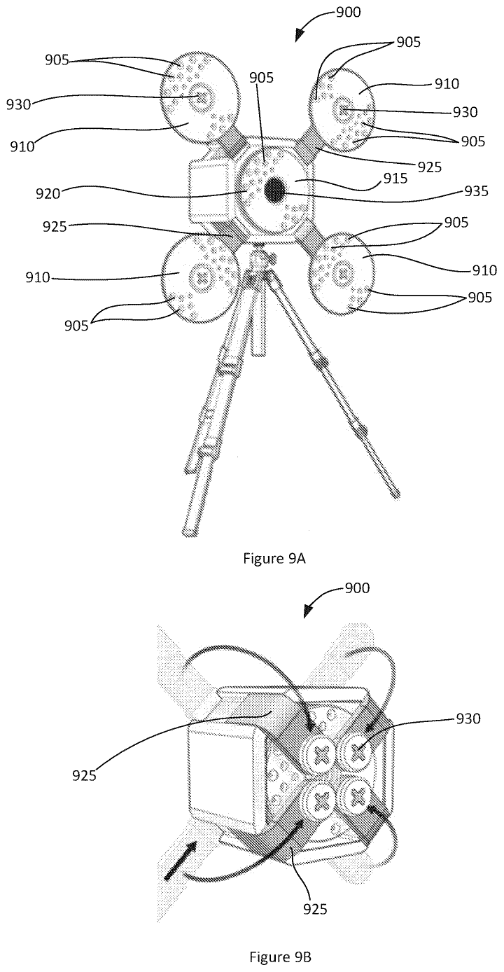

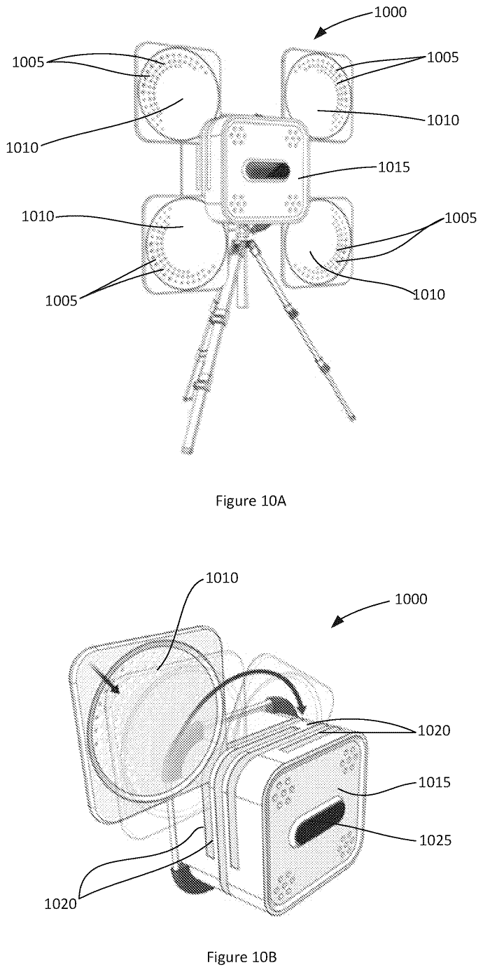

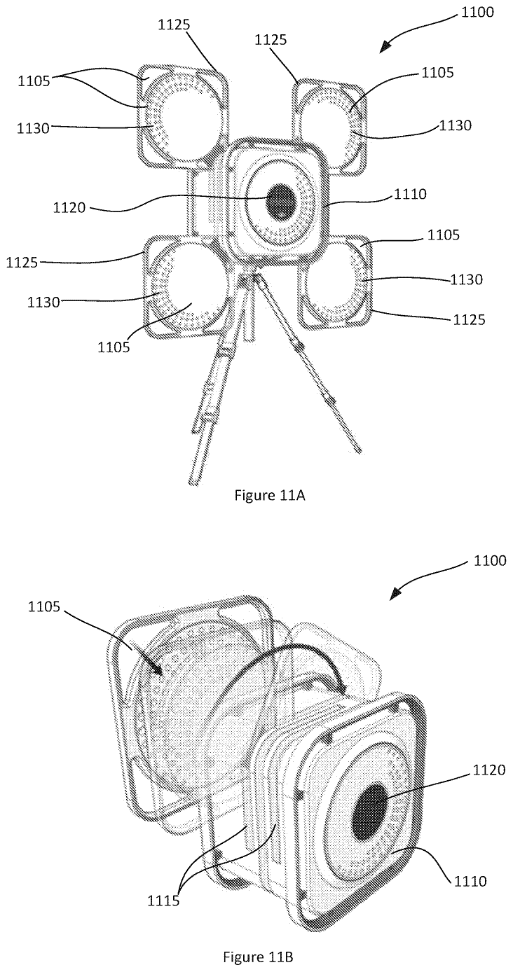

Finally, referring to FIGS. 11A and 11B, there is shown yet another embodiment of the acoustic sensing system 1100, which similarly to acoustic sensing system 1000 shown in FIGS. 10A and 10B provides for sensor mounting members 1105 to be disconnected from housing 1110 when not is use and received in a slot 1115 provided in housing 1110 for storage and transport. In this embodiment, sensor mounting members are generally disc-shaped but surrounded by an angular frame 1125. Angular frame 1125 is easy to grasp in the hand and further serves to protect sensor mounting members 1105 bearing acoustic sensing elements 1130 from knocks and the like. Acoustic sensing system 1100 further differs from acoustic sensing system 1000 in the distribution of acoustic sensing elements 1130 on the front face of housing 1120, and additionally, in the shape of camera aperture 1120.

FIG. 11B shows how sensor mounting members 1105 are discretely stored in slots 1115 when not in use. Similarly, to sensor mounting members described with reference to FIGS. 10A and 10B, the sensor mounting members 1105 are configured to be disconnected from housing 1110 by releasable connection means and are each received into a slot 1115 provided in housing 1110 for that purpose.

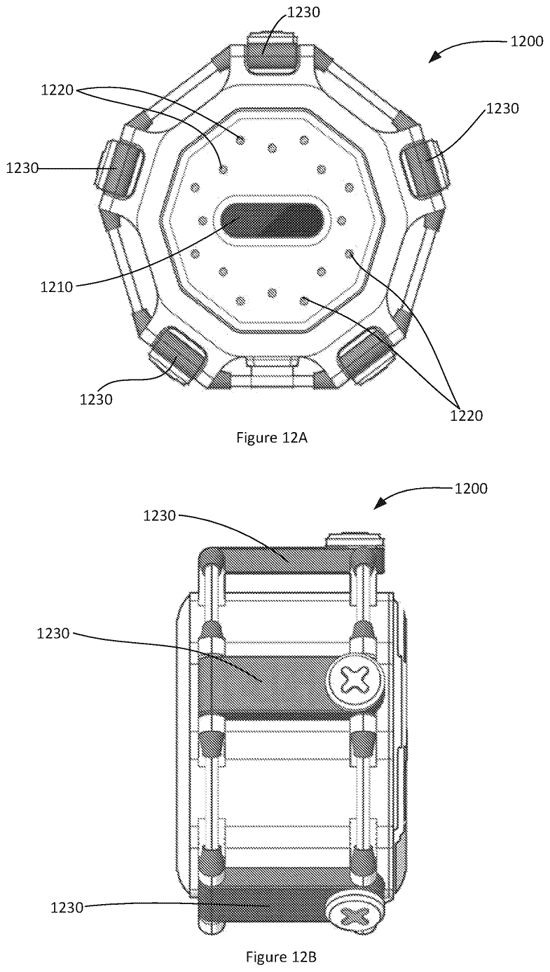

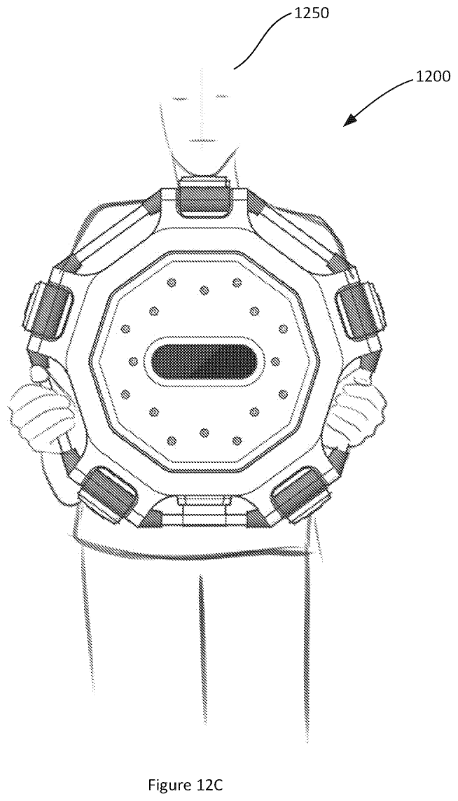

Now shown in FIGS. 12A and 12B is a close-up view of a housing 1200 according to an embodiment. Housing 1200 includes a horizontal optical camera aperture 1210 and a fixed distribution of acoustic sensing elements 1220. It will be understood that the illustrated configurations and distributions are exemplary only and could take other forms without departing from the spirit of the invention. Sensor mounting members (not shown) also bearing acoustic sensing elements, are connected to housing by means of hinged members 1230. Hinged members 1230 may include more than one hinge, to enable the hinged member to be folded discretely around a side of housing 1200 such that sensor mounting members can be retained in an opening provided at the rear of housing, configured to receive the same. Whilst the housing shown in FIGS. 12A and 12B bears similarly to that shown in FIGS. 8A and 8B, the number of hinged members 1230 provided differs, being five in the embodiment shown in FIGS. 12A and 12B and four in the embodiments shown in FIGS. 8A and 8B. Therefore, it will be appreciated, that any number of hinged members that can be accommodated on a housing, may be provided, for mounting any suitable number of sensor mounting members without departing from the spirit of the invention.

Referring now to FIG. 12C, there is shown the housing 1200 of FIGS. 12A and 12B held by a person or user 1250, to show the comparative size. It will be appreciated that the housing 1200 could be larger or smaller as required, but is intended to show the compact nature of the acoustic sensing system according to some embodiments.

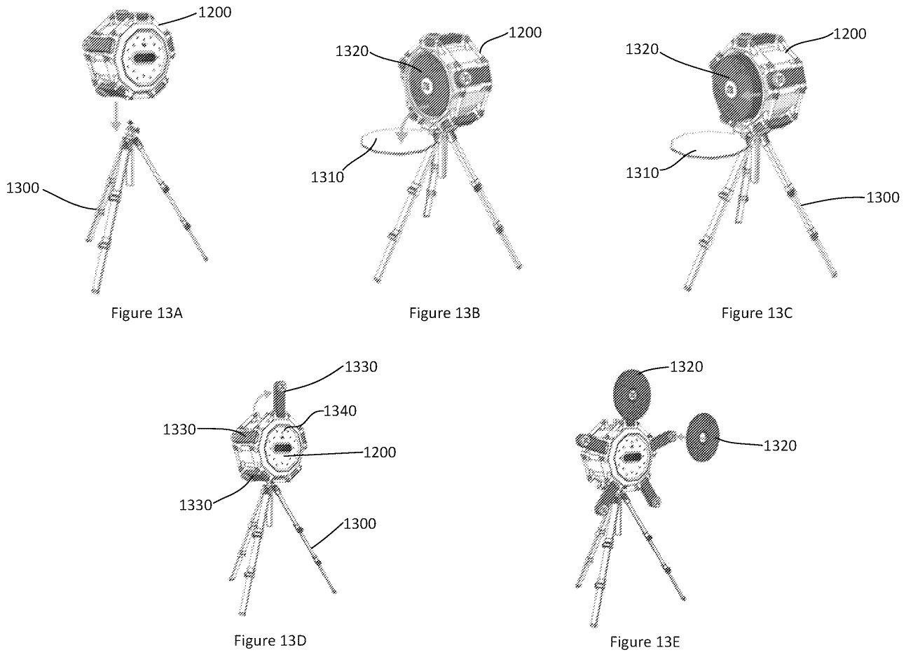

Referring now to FIGS. 13A, 13B, 13C, 13D and 13E, there is shown the embodiment shown in FIGS. 12A, 12B and 12C, highlighting various features. More specifically, the acoustic sensing system is shown in various stages of use. In FIG. 13A, the housing 1200 is placed upon a portable tripod having telescopic legs 1300. This provides adjustable height and stability to the acoustic sensing system. In FIG. 13B, a cover 1310 provided on rear storage compartment of housing 1200 is shown in the open position. With cover 1310 in the open position, access is provided to sensor mounting members 1320 stored therein. In FIG. 13C, cover 1310 is shown in the open position, and sensor mounting members 1320 are released from the storage compartment to sit proud of the edge of rear storage compartment. In FIG. 13D, hinged members 1330 which were discretely folded around sides of housing 1200, have been moved to an “in use” position, wherein the hinged members 1330 are positioned in the same plane as front face of housing 1200.

In the illustrated embodiment, there are five hinged members 1330 for mounting five sensor mounting members 1320. It will be appreciated that there could be more or less hinged members and sensor mounting members provided that the numbers of each coincide. FIG. 13E shows some sensor mounting members 1320 mounted on hinged members 1330 which have been extended. Sensor mounting members 1320 are shown mounted on hinged members 1330 such that the front facing surface of each sensor mounting member lies in the same plane as the front face 1340 of housing 1200.

In order to achieve an optimised configuration for the acoustic sensing array which focuses the acoustic sensor elements on a particular sound source or enhances focus on one or more selected sound sources, the moveable sensor mounting members are moved in one or more of the following ways. Sensor mounting member can be rotated about a pivot provided on a distal end of hinged member. Rotating the moveable elements, show here as lobes or discs, alters the relative positions of the acoustic sensing elements provided on each disc. That is, since acoustic sensing elements have an irregular, if not random, distribution across the planar surface of each disc. Rotating one or more sensor mounting members can, for example, bring acoustic sensing elements located on adjacent lobes closer to together or further apart. Additionally, sensor mounting members can be moved forwards or backwards in space, relative to the housing of the acoustic sensing system. It will be appreciated that this combination of individual movements allows acoustic sensor elements to be moved relative to all other acoustic sensor elements, thereby enabling the acoustic sensor array to be optimised to focus on a particular sound source or enhance focus on one or more selected sound sources.

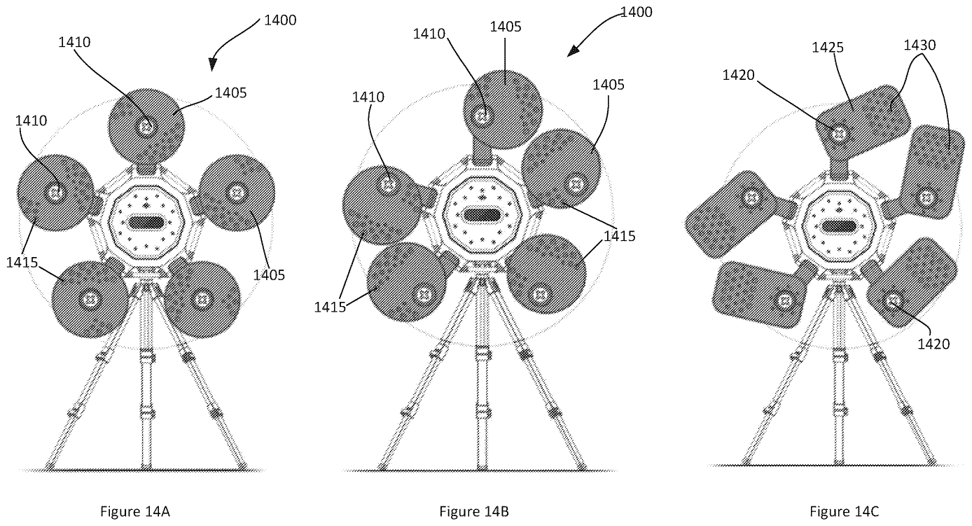

Referring now to FIGS. 14A and 14B there is shown how different acoustic sensor array configurations may be achieved by rotating the sensor mounting members 1405 about pivot 1410 relative to one another. Sensor mounting members 1405 are in the form of lobe or disc-shaped members bearing acoustic sensing elements 1415. FIG. 14A shows an initial configuration. FIG. 14B shows the same acoustic sensing system 1400 with the acoustic sensor array in a modified configuration. In the configuration illustrated in FIG. 14B, each of sensor mounting member 1405 has been rotated left or right to optimise the acoustic sensor array. What constitutes an optimised configuration will depend on the sound sources present in the area of interest and any parameters set by the user.

Finally, referring now to FIG. 14C. there is shown a similar configuration or arrangement of sensor mounting members 1425 mounted via pivot 1420. Sensor mounting members 1425 are rotated left or right to vary the position of the acoustic sensing elements 1430 from their initial position to optimise the configuration of the acoustic sensor array. In the embodiment shown in FIG. 14C, sensor mounting members have an angular or rectangular shape rather than the disc-like geometry shown in FIGS. 14A and 14B. It will be appreciated that the same end can be achieved with planar surfaces in a variety of different shapes which are not limited to a disc-like or rectangular shapes.

The control mechanism or actuation means for moving each planar element can be selected from any suitable means, including but not limited to one or more electric motors, pneumatic or manual means. Similarly, the hinged members or other connection means upon which the sensor mounting members are mounted may be moved in the same manner.

The above-mentioned factors may be optimised to allow for either asynchronous and synchronous (i.e. real or near-real time) adaptation of the acoustic sensor array to enhance the resulting acoustic maps. Asynchronous adapting occurs when the microphone array is adapted whilst the acoustic sensing system is not recording. This comprises iterative steps of (1) generating an acoustic map, (2) determining using currently available inputs the optimal acoustic sensing array, followed by (3) adjusting acoustic sensing array to enhance the resulting acoustic map. These steps are continuously repeated until the acoustic map is optimised for given area of interest. Synchronous adapting occurs when the acoustic sensing array is adapting while the acoustic sensing system is recording.

Referring back to FIG. 5, in other embodiments (not shown), the acoustic sensing array 610 comprises a plurality of detachable acoustic sensing elements 620 or microphones that are controlled or actuated in similar manner as the adaptable mechanical array described by reference to FIGS. 7 to 14C. Alternatively, the acoustic sensing elements 620 can be mounted on a support capable of autonomous movement such as an UAV or a ROV. In this case, the autonomously moveable support enables the spatial position of the acoustic sensing elements to be adjusted relative to the sound source or sources. In this example, the acoustic sensing elements transmit wirelessly the sensed acoustic data to a central processor that processes the acoustic map.

That is, it will be appreciated that the spatial position or mounting of the acoustic sensor elements is not limited to a physical frame or support structure. Provided the precise location of each acoustic sensing element is known, the relative positive can be varied to enhance the acoustic map. Mounting the acoustic sensing elements to a UAV or ROV has particular utility in the case of detecting low frequency sounds, where large spacings between the acoustic sensing elements are desirable. Moreover, any high frequency sound that may be emitted from the UAV or ROV should not cause any interference.

In yet another embodiment, one or more acoustic sensing elements are suspended within a rigid frame mounted between wires, which can be lengthened or shortened in response to a control signal to adjust the spatial position of each acoustic sensing element. As in the previously described embodiments, it will be understood that a shape memory alloy actuator wire or similar could be utilised to provide the requisite spatial adjustment.

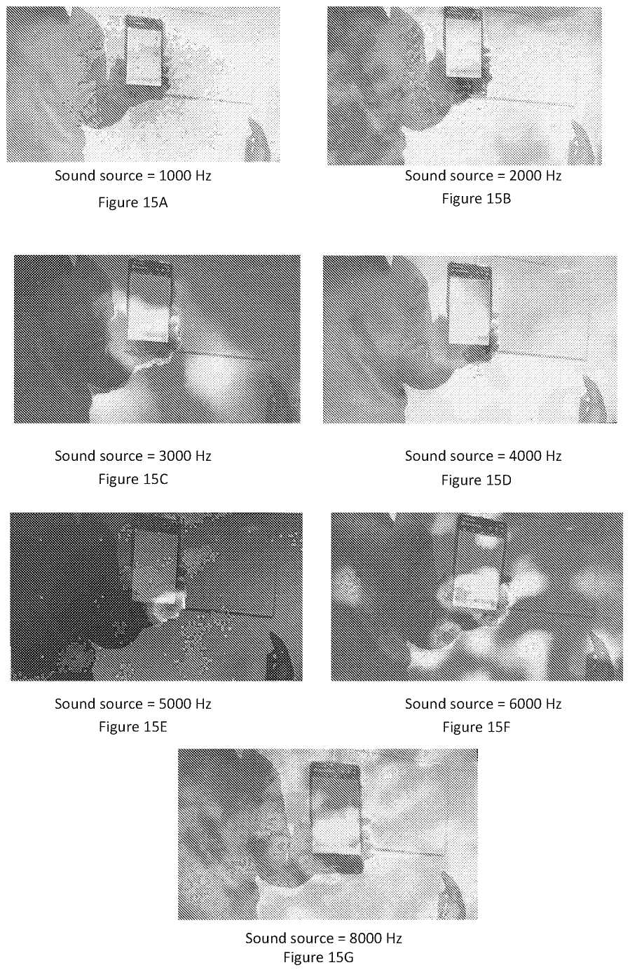

Referring now to FIGS. 15A to 15G there is illustrated the phenomenon that sound sources having different frequencies will produce different acoustic maps when sensed using an identical acoustic sensing array. This demonstrates via the principle of reciprocity that an acoustic sensing array that is optimised to sense one particular sound source will not necessarily be optimal for sensing a different sound source. When viewed alongside FIGS. 6A and 6B which utilise two different acoustic sensing arrays having a fixed topology which representative of a variety of acoustic camera configurations that are currently available on the market, it will be appreciated that each acoustic sensor array configuration is optimised for a different sound type, confirming that a single fixed geometry or topology will not be optimal for all environments. The above examples serve to illustrate that the acoustic sensing system having an acoustic sensing array with an adaptable configuration should improve the quality of acoustic maps when compared with those captured using current fixed acoustic sensing array technology, which can only be truly optimal for a single sound source characteristic scenario.

The optimisation performed by the second processor 650 (see FIG. 5) has an objective defined in mathematical terms, typically referred to as a “cost function” in machine learning. A machine learning optimiser uses heuristic approaches to improve a cost function, which is a numerical measure of the quality of the output. Cost functions for the acoustic sensing system can be broadly defined and varied to achieve different objectives, e.g. to pinpoint a sound source most precisely, to minimise background noise, to suppress unwanted artefacts, or to detect multiple sound sources. Examples of some potential but non-limiting cost functions are provided below:
a. the prominence of the main peak (i.e. the height in decibels (dB) above the surrounding level);
b. the width of the main peak (i.e. the average radius at which the sound level is 3 dB (or some other predetermined value) below the main peak;
c. searching for a particular sound characteristic (i.e. spectral content);
d. to maximise the centre pixel's magnitude of a single sound source relative to the average background level on the acoustic map;
e. to maximise the ratio of centre lobe's energy of a single sound source to the adjacent side-lobes of the same sound source;
f. to minimise the average radius of half-energy-contour of the main lobe;
g. to minimise or remove the side-lobe(s) on a single sound source;
h. to maximise the average of all the detected sound sources' centre main lobe on the acoustic map;
i. to minimise the standard deviation on the main lobe's magnitude of the single sound source;
j. to minimise the percentage spatial jitter on each detected lobe;
k. to maximise the main lobe's magnitude of all sound sources in a particular frequency band; and/or
l. a function that combines any of the above.

Referring back to FIG. 5, a machine learning algorithm is used by processor 650 to explore in which direction to one or more acoustic elements 620 should be moved and/or have their gain adjusted, in order to optimise the mathematically defined objective, e.g. maximising prominence of the main peak, minimising width of the main peak, or the like. The machine learning algorithm enables a thorough exploration of the possible solutions to be performed in a viable amount of time based on various assumptions. The machine learning algorithm will typically commence by making significant adjustments to the acoustic camera to identify all sound sources within the area of interest. The machine learning algorithm then explores regions around the current acoustic map to obtain gradient estimations towards the cost function. This can be accomplished, for example, using several gradient based methods of hill-climbing algorithms. Once an initial gradient is determined, an initial search line is applied to the direction of improving the cost functions followed by intermediate conjugated line searches. In response, the configuration of the acoustic sensor array 610 is adjusted incrementally. The adjustments may be small or large and are controlled via acoustic sensing system 600. A controller deploys the requisite signals to ensure the adjustment is executed, for example, by applying a predetermined amount of electrical current to contract and/or expand a muscle wire to move an arm, as will become clearer from reading the ensuing description. After each incremental adjustment to the acoustic sensor array 610, a new acoustic map is generated, and the machine learning algorithm is provided with a new acoustic map which is compared to the immediately previous version of the acoustic map to compute a new gradient or difference map. Boundary conditions may be applied to set limits on the movement of the acoustic sensor array 610.

It will be appreciated that in any optimisation problem; the global optimum or best solution may be identified without using a machine learning algorithm if all permutations are tested. For example, in the case of optimising an acoustic sensor array for an acoustic camera, this would involve considering every possible configuration or arrangement of the acoustic sensing elements (spacing and location) and their respective gain, to find the optimal acoustic sensor array topology, which is simply impractical given time and resourcing limitations.

Machine learning algorithms make assumptions to severely reduce the vast number of possible configurations or permutations, and adjust and attempt different permutations to make predictions. Based on its inherent algorithm set, it may try to improve the cost function associated with the desired outcome.

Based on the selected cost function, there will be various options for adaptation. In a simple environment, e.g. a single sound source with a known frequency, the power spectral density of the sound source is measured in a particular bandwidth and the key frequency identified such that the spacings of the acoustic sensor elements are adjusted to optimise capturing sound at this frequency. Assuming that acoustic wave reflection due to the surrounding environment is minimal and that the side-lobes on the main beam are not caused by slight aperiodic sampling times, the adjustment should be both linear and straightforward.

A user can identify a key sound source of interest (for example, by tapping on the area of interest on the display in the case of a touch screen) in an environment containing multiple sound sources, and similar processing can be performed after isolating other sound sources using spatial filters or any other applicable technique.

In the case of a more challenging environment that causes multiple distortions to the sound source estimation, e.g., acoustic map artefacts, many minor attempted adjustments to the spatial position of the acoustic sensing elements may be required to observe significant improvement. In another case, it may be desirable to measure numerous sound sources having different frequency sets. This can be achieved using the acoustic sensing system of the present invention by adjusting subsets of acoustic sensing elements to map to different sound sources. The level of customisation to the surrounding environment is limited only by the number of acoustic sensing elements available within the system, the adaptability of each acoustic sensing element in terms of spatial positioning and gain, and the environment itself, etc.

It will be appreciated that any adjustment to the spatial location of individual acoustic sensing elements will not be instantaneous, and so any adjustment to the configuration will slow processing, especially where the sound source is not continuously available to be sensed.

Examples of various machine learning optimisers suitable for implementation in an acoustic sensing system are:
A simple gradient descent algorithm: a basic second order approach relying on unconstrained convex optimisation. First an acoustic map is created of the initial configuration and then makes several perturbations to the configuration of the acoustic sensing array (this could be as simple as moving all acoustic sensing elements closer or further away from the centre, one at a time). Once the direction of movement of the acoustic sensing elements that provides an improvement to the cost function is identified, it is assumed to be the direction of gradient improvement. Progression in that direction is accelerated using learning rates or momentum rates (basically speeding up in that direction with confidence if successive optimisations provide improvement). Iterations continue until the cost function begins to deteriorate and then minor adjustments are made to the previous solution.
A conjugate gradient descent algorithm: similar to the gradient descent algorithm, but using simple conjugate gradient line searches in orthogonal directions to get an improved estimation of changes in the gradient for optimising the cost function.
An ideal control algorithm will adopt a global optimum geometry for a given sound source. The challenges are (i) that it may require frequent large step-changes to the configuration if the sound source is not constant, and (ii) gradient descent methods will easily and smoothly find a local optimum, but may not converge to a global optimum, which may be significantly superior. A method to find a solution close to the global optimum configuration might exploit prior knowledge or more advanced machine learning methods as follows:
   A machine learning classifier (such as but not limited to ANN, SVM, LDA, CNN, deep learning) is first used to classify the main (and possibly secondary) sound source(s). It could identify general classes (e.g. pure or harmonic/narrow band/broadband), specific pre-defined classes (e.g. bird calls, traffic, rotating machinery, gas leaks) or a superset of both. It would identify other important features (e.g. continuous or intermittent, stationary or moving, single or multiple) that would feed into decisions about the speed and extent of the adjustments to the acoustic sensing array configuration.
   Alternatively, a user could be given the option to select the source type, or a subset of types, to assist the classifier.
   After classifying the source, key defining parameters are identified (e.g. frequency range, approximate direction).
   The global optimum configuration subject to system constraints for a representative range of sound source types would be pre-computed using simulation of an ideal acoustic sensing system (possibly with refinement based on physical testing and calibration), and programmed into the system as a ‘lookup’ feature.
   In real time, the processor compares the identified source type and its defining parameters with the pre-computed database to define a ‘base configuration’.
   Starting from the base configuration, the gradient descent algorithm is used to fine-tune the optimised configuration.
   The gradient descent algorithm is coupled with a feedback loop that steers the solution weakly back towards the base configuration, so that the fine-tuning process does not take the configuration too far away from the base configuration (and possibly towards an undesirable local solution), until such time that the sound source is reclassified.
   The optimiser runs continuously, while the classifier may only need to update infrequently or at regular intervals depending on the sound source type and the likelihood of it changing.

It will be appreciated that virtually any machine learning optimiser could be applied to the problem, each having its own advantages and disadvantages. The ability to adapt the acoustic sensing array provides the true essences of the invention.

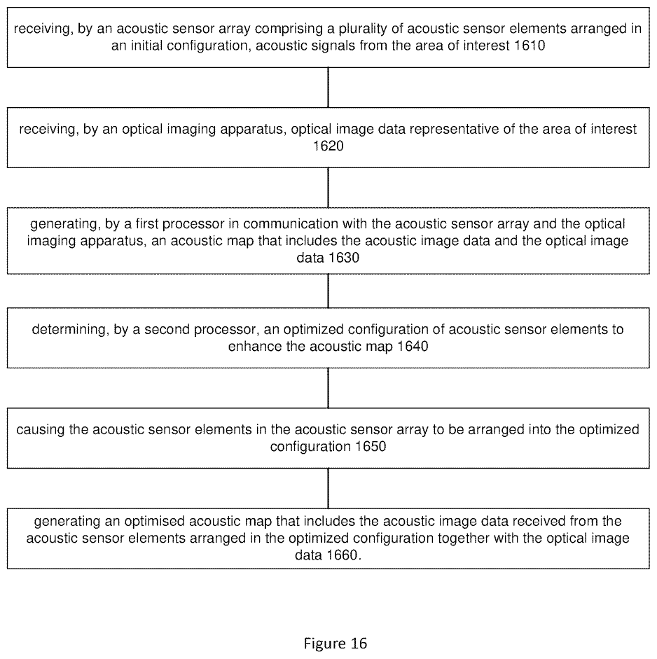

Referring now to FIG. 16, there is shown a method 1600 of producing an acoustic map of an area of interest including one or more sound sources, the method comprising the following steps receiving, by an acoustic sensor array comprising a plurality of acoustic sensor elements arranged in an initial configuration, acoustic data from the area of interest 1610; receiving, by an optical imaging apparatus, optical image data representative of the area of interest 1620; generating an acoustic map that includes the acoustic data and the optical image data 1630; determining an optimised configuration of acoustic sensor elements to enhance the acoustic map 1640; causing the acoustic sensor elements in the acoustic sensor array to be arranged into the optimised configuration 1650; and generating an optimised acoustic map that includes the acoustic data received from the acoustic sensor elements arranged in the optimised configuration together with the optical image data 1660. It will be appreciated that the step of generating an acoustic map may be carried out by a first processor and the step of determining an optimised configuration of acoustic sensor elements may be carried out by a second processor in communication with the acoustic sensor array and the optical imaging apparatus. In some embodiments, both processors may reside on the same chip, i.e. processor.

The steps of generating the acoustic map, determining the optimised configuration of acoustic sensor elements to enhance the acoustic map and causing the acoustic sensor elements in the acoustic sensor array to be arranged into the optimised configuration are repeated until the acoustic map is optimised for the area of interest.

The step of determining an optimised configuration of acoustic sensor elements to enhance the acoustic map involves performing one or more of the following steps:
establishing a frequency range of one or more sound sources and adjusting the spacing between acoustic sensor elements for each sound source;
repositioning the acoustic sensor array in response to potential obstructions in an environment surrounding the area of interest;
varying a relative angle of each acoustic sensing element to enhance side-lobe suppression; and/or
adjusting a subset of the acoustic sensing elements for each sound source detected, e.g. adjusting the spatial position and/or the gain of one or more acoustic sensing elements.

Various modifications and variations to the described acoustic sensing system are envisaged without departing from the scope and spirit of the invention. For example, the addition of other input sources such as geometric sensors, stereoscopic cameras, ranger finders, LiDAR, etc. that could be used to provide more detailed surveys of the environment.

The acoustic system of the present invention offers a number of advantages over existing acoustic camera system which are generally limited to a fixed topology. In accordance with the invention, the acoustic sensor elements in the acoustic sensor array can be reconfigured to adapt the acoustic sensing system to optimise acoustic sensing in a particular environment. This improved functionality makes the acoustic sensing system suitable for a broader variety of environments than conventional acoustic sensing systems. Moreover, it improves the quality of the acoustic map that may be generated using such systems, since the acoustic sensing array is optimised to enhance the map output for a given scenario or setting.

Where any or all of the terms “comprise”, “comprises”, “comprised” or “comprising” are used in this specification (including the claims), they are to be interpreted as specifying the presence of the stated features, integers, steps or components, but not precluding the presence of one or more other features, integers, steps or components.

While the invention has been described in conjunction with a limited number of embodiments, it will be appreciated by those skilled in the art that many alternatives, modifications and variations in light of the foregoing description are possible. Accordingly, the present invention is intended to embrace all such alternatives, modifications and variations as may fall within the spirit and scope of the invention as disclosed.

1-22. (canceled)

23. An acoustic sensing system for generating an acoustic map to identify one or more sounds sources in an area of interest comprising:
an acoustic sensor array comprising a plurality of acoustic sensor elements arranged in an initial configuration, each acoustic sensor element being configured to receive acoustic data from the area of interest including the one or more sound sources;
an optical imaging apparatus comprising an image sensor configured to receive optical image data representative of the area of interest;
one or more processors in communication with the acoustic sensor array and the optical imaging apparatus, the processor configured to:
generate an acoustic map that includes the acoustic data and the optical image data;
determine an optimised configuration of acoustic sensor elements to enhance the acoustic map;
cause the acoustic sensor elements to be arranged into the optimised configuration; and
generate an optimised acoustic map that includes the acoustic data received from the acoustic sensor elements arranged in the optimised configuration together with the optical image data;
wherein the optimised configuration includes adjustments to the acoustic sensor elements to focus on a particular sound source or enhance focus on one or more selected sound sources.

24. The acoustic sensor system according to claim 23, wherein the optimised configuration includes a varied spatial position of one or more of the plurality of acoustic sensor elements in the acoustic sensor array.

25. The acoustic sensor system according to claim 23, wherein the optimised configuration includes a varied gain of one or more of the plurality of acoustic sensor elements in the acoustic sensor array.

26. The acoustic sensor system according to claim 23, wherein the optimised configuration includes a varied spatial position and a varied gain of one or more of the plurality of acoustic sensor elements in the acoustic sensor array.

27. The acoustic sensor system according to claim 23, wherein the processor determines an optimised configuration of the acoustic sensor elements to enhance the acoustic data received from the area of interest using an optimisation algorithm.

28. The acoustic sensor system according to claim 23, wherein the acoustic sensor array comprises a plurality of acoustic sensor elements arranged on one or more sensor mounting members extending from a housing.

29. The acoustic sensor system according to claim 28, wherein the one or more sensor mounting members are rotatably mounted to a hinged member extending from the housing.

30. The acoustic sensor system to claim 28, wherein each sensor mounting member has at least one acoustic sensor element arranged thereon to allow for movement of acoustic sensor elements relative to other acoustic sensor elements.

31. The acoustic sensor system according to claim 28, further including actuation means configured to arrange the acoustic sensor elements into the optimised configuration.

32. The acoustic sensor system according to claim 28, wherein the one or more sensor mounting members each comprise an arm, each arm being hingedly connected to a support structure.

33. The acoustic sensor system according to claim 32, wherein each arm comprises a plurality of segments, each segment being hingedly connected to an adjoining segment.

34. The acoustic sensor system according to claim 33, wherein each segment has at least one acoustic sensor element arranged thereon to allow for movement of each acoustic sensor element relative to each other acoustic sensor element.

35. The acoustic sensor system according to claim 28, further including actuation means configured to arrange the acoustic sensor elements within the acoustic sensor array mounted on sensor mounting members to be arranged into the optimised configuration.

36. A method for generating an acoustic map to identify one or more sound sources in an area of interest, the method comprising the following steps:
receiving, by an acoustic sensor array comprising a plurality of acoustic sensor elements arranged in an initial configuration, acoustic data from the area of interest;
receiving an optical image data representative of the area of interest;
generating an acoustic map that includes the acoustic data and the optical image data;
determining an optimised configuration of acoustic sensor elements to enhance the acoustic map;
causing the acoustic sensor elements in the acoustic sensor array to be arranged into the optimised configuration; and
generating an optimised acoustic map that includes the acoustic data received from the acoustic sensor elements arranged in the optimised configuration together with the optical image data;
wherein the optimised configuration includes adjustments to the acoustic sensor elements to focus on a particular sound source or enhance focus on one or more selected sound sources.

37. The method according to claim 36, wherein the optimised configuration includes varying a spatial position of one or more of the plurality of acoustic sensor elements in the acoustic sensor array.

38. The method according to claim 36, wherein the optimised configuration includes varying a gain of one or more of the plurality of acoustic sensor elements in the acoustic sensor array.

39. The method according to claim 36, wherein the optimised configuration includes varying a spatial position and varying a gain of one or more of the plurality of acoustic sensor elements in the acoustic sensor array.

40. The method according to claim 36, wherein the steps of generating the acoustic map, determining the optimised configuration of acoustic sensor elements to enhance the acoustic map and causing the acoustic sensor elements in the acoustic sensor array to be arranged into the optimised configuration are repeated until the acoustic map is optimised for the area of interest.

41. The method according to claim 36, wherein the step of determining an optimised configuration of acoustic sensor elements to enhance the acoustic map involves performing one or more of the following steps:
a. establishing a frequency range of one or more selected sound sources and adjusting a spacing between acoustic sensor elements for each sound source;
b. repositioning the acoustic sensor array in response to potential obstructions in an environment surrounding the area of interest;
c. varying a relative angle of each acoustic sensor element to enhance side-lobe suppression; and/or
d. adjusting a subset of the acoustic sensor elements for each sound source detected.

42. The method according to claim 41, wherein adjusting a subset of the acoustic sensor elements for each sound source detected includes adjusting the spatial position and/or the gain of one or more acoustic sensing elements.
